(19) United States
(12) Patent Application Publication
(10) Pub. No.: US 2021/0319153 A1
(43) Pub. Date: Oct. 14, 2021

(54) METHOD AND SYSTEM FOR DETERMINING TECHNICAL LIMIT WELL SPACING FOR CHEMICAL FLOODING FOR HEAVY-OIL RESERVOIR

(71) Applicants: China University of Petroleum (East China), Qingdao (CN); Shengli Oilfield Branch of China Petrochemical Corporation, Shandong (CN)

(72) Inventors: Chuanzhi Cui, Qingdao (CN); Zhongwei Wu, Qingdao (CN); Zhen Wang, Qingdao (CN); Yingfei Sui, Qingdao (CN); Wenqian Zheng, Qingdao (CN); Yangwen Zhu, Qingdao (CN); Fuqing Yuan, Qingdao (CN); Tongyu Yao, Qingdao (CN); Haijun Fan, Qingdao (CN)

(21) Appl. No.: 17/028,710

(22) Filed: Sep. 22, 2020

(30) Foreign Application Priority Data
Apr. 14, 2020 (CN) 202010288519.X

(51) Int. Cl. G06F 30/20; E21B 43/16; E21B 43/30; E21B 49/00

(52) U.S. Cl. CPC G06F 30/20; E21B 43/16; G06F 2111/10; E21B 49/00; E21B 2200/20; E21B 43/30

(57) ABSTRACT

The present disclosure relates to a method and system for determining a technical limit well spacing for chemical flooding for a heavy-oil reservoir. This method includes: establishing a reservoir numerical simulation model; setting up injection and production wells according to a set well spacing, and using the reservoir numerical simulation model to calculate an average pressure, an average crude oil viscosity and an average permeability at each grid point between the injection and production wells within m days; calculating a driving pressure gradient of each grid point, and drawing a driving pressure gradient curve; calculating a starting pressure gradient of each grid, and drawing a starting pressure gradient curve; determining a relationship between the driving pressure gradient curve and the starting pressure gradient curve. In this manner the present disclosure calculates the limit well spacing for chemical flooding for the heavy-oil reservoir after steam stimulation.

### CLAIM OF PRIORITY UNDER 35 U.S.C. § 119

This application claims priority to Chinese Patent Application No. 202010288519. X, filed on Apr. 14, 2020, the entire content of which are incorporated herein by reference.

### TECHNICAL FIELD

The present disclosure relates to the field of heavy-oil well spacing, in particular to a method and system for determining a technical limit well spacing for chemical flooding for a heavy-oil reservoir after steam stimulation.

### BACKGROUND

After multiple cycles of steam stimulation (a thermal recovery method) in the heavy-oil reservoir, the formation pressure drops significantly, the cyclic oil production declines, and the development effect and economic benefits gradually get worse, and the enhancement of oil recovery is severely restricted. The conversion of steam stimulation to chemical flooding is an effective replacement method to achieve stable production of the heavy-oil reservoir. Chemical flooding is a method of injecting a viscosity reducer to reduce the viscosity of the heavy oil and improve the mobility of the heavy oil in the reservoir. Technical limit well spacing is an important basis for ensuring the flooding effect, determining the location of the new well and adjusting the operational measures of the old well. If the designed well spacing is excessively large, the pressure gradient between the injection and production wells will not reach the starting pressure gradient, and there will be a non-flowing area, resulting in a poor flooding effect.

### SUMMARY

In order to enhance the heavy-oil reservoir recovery, an objective of the present disclosure is to provide a method and system for determining a technical limit spacing when drilling a new well in a heavy-oil reservoir after multiple cycles of steam stimulation.

To achieve the above purpose, the present disclosure provides the following technical solutions.

In one aspect, a method for determining a technical limit well spacing for chemical flooding for a heavy-oil reservoir is disclosed, and includes:

S1: establishing a reservoir numerical simulation model by using reservoir numerical simulation software according to time-varying characteristics of a viscosity reducing agent on the viscosity of an oil phase and a water phase;

S2: setting up injection and production wells according to a set well spacing, and using the reservoir numerical simulation model to calculate an average pressure, an average crude oil viscosity and an average permeability at each grid point between the injection and production wells within m days;

S3: calculating a driving pressure gradient of each grid point according to the average pressure of each grid point, and drawing a driving pressure gradient curve;

S4: calculating a starting pressure gradient of each grid according to the average permeability and average crude oil viscosity of each grid point, and drawing a starting pressure gradient curve; and

S5: determining a relationship between the driving pressure gradient curve and the starting pressure gradient curve; determining that the well spacing is excessively large if the driving pressure gradient curve intersects with the starting pressure gradient curve, then reducing the well spacing according to a set ratio, and repeating steps S2 to S5; determining that the well spacing is excessively small if the driving pressure gradient curve is separated from the starting pressure gradient curve, then increasing the well spacing according to a set ratio, and repeating steps S2 to S5; and determining the well spacing as a limit well spacing when the driving pressure gradient curve is tangent to the starting pressure gradient curve.

Preferably, the driving pressure gradient of each grid point is specifically calculated by:

$$D {r}_{i} = \{ \begin{matrix}\frac{p ( i ) - p ( i + 1 )}{\frac{1}{2} ( x ( i ) + x ( i + 1 ) )} & ( i = 1 , 2 , … , n - 1 ) \\ D {r}_{i - 1} & ( i = n )\end{matrix} ;$$

where, Drᵢ is a driving pressure gradient of an i-th grid point; n is a number of grid points; p(i) is an average pressure of the i-th grid point; x(i) is a length of the i-th grid point.

Preferably, the starting pressure gradient of each grid is specifically calculated by:

Gₒ=10^{A+BIg(K/μ}^{ₒ}⁾;

where, Gₒ is a starting pressure gradient; A and B are set coefficients; K is an average permeability; μ₀ is an average crude oil viscosity.

Preferably, m is 30, and n is 80.

The present disclosure further provides a system for determining a technical limit well spacing for chemical flooding for a heavy-oil reservoir, including:

a model establishment module, for establishing a reservoir numerical simulation model by using reservoir numerical simulation software according to time-varying characteristics of a viscosity reducing agent on the viscosity of an oil phase and a water phase;

a calculation module, for setting up injection and production wells according to a set well spacing, and using the reservoir numerical simulation model to calculate an average pressure, an average crude oil viscosity and an average permeability at each grid point between the injection and production wells within m days;

a driving pressure determination module, for calculating a driving pressure gradient of each grid point according to the average pressure of each grid point, and drawing a driving pressure gradient curve;

a starting pressure determination module, for calculating a starting pressure gradient of each grid according to the average permeability and average crude oil viscosity of each grid point, and drawing a starting pressure gradient curve; and

a limit well spacing determination module, for determining a relationship between the driving pressure gradient curve and the starting pressure gradient curve; determining that the well spacing is excessively large if the driving pressure gradient curve intersects with the starting pressure gradient curve, then reducing the well spacing according to a set ratio, and returning to the calculation module; determining that the well spacing is excessively small if the driving pressure gradient curve is separated from the starting pressure gradient curve, then increasing the well spacing according to a set ratio, and returning to the calculation module; and determining the well spacing as a limit well spacing when the driving pressure gradient curve is tangent to the starting pressure gradient curve.

Preferably, the driving pressure gradient of each grid point is specifically calculated by:

$$D {r}_{i} = \{ \begin{matrix}\frac{p ( i ) - p ( i + 1 )}{\frac{1}{2} ( x ( i ) + x ( i + 1 ) )} & ( i = 1 , 2 , … , n - 1 ) \\ D {r}_{i - 1} & ( i = n )\end{matrix} ;$$

where, Drᵢ is a driving pressure gradient of an i-th grid point; n is a number of grid points; p(i) is an average pressure of the i-th grid point; x(i) is a length of the i-th grid point.

Preferably, the starting pressure gradient of each grid is specifically calculated by:

Gₒ=10^{A+BIg(K/μ}^{ₒ}⁾;

where, Gₒ is a starting pressure gradient; A and B are set coefficients; K is an average permeability; μ₀ is an average crude oil viscosity.

Preferably, m is 30, and n is 80.

According to the specific examples provided by the present disclosure, the present disclosure discloses the following technical effects.

In some embodiments, the present disclosure relates to a method and system for determining a technical limit well spacing for chemical flooding for a heavy-oil reservoir. This method includes: establishing a reservoir numerical simulation model; setting up injection and production wells according to a set well spacing, and using the reservoir numerical simulation model to calculate an average pressure, an average crude oil viscosity and an average permeability at each grid point between the injection and production wells within m days; calculating a driving pressure gradient of each grid point, and drawing a driving pressure gradient curve; calculating a starting pressure gradient of each grid, and drawing a starting pressure gradient curve; determining a relationship between the driving pressure gradient curve and the starting pressure gradient curve; determining that the well spacing is excessively large if the driving pressure gradient curve intersects with the starting pressure gradient curve, then reducing the well spacing according to a set ratio, and repeating the above steps; determining that the well spacing is excessively small if the driving pressure gradient curve is separated from the starting pressure gradient curve, then increasing the well spacing according to a set ratio, and repeating the above steps; and determining the well spacing as a limit well spacing when the driving pressure gradient curve is tangent to the starting pressure gradient curve. By the above method, the present disclosure can calculate the limit well spacing for chemical flooding for the heavy-oil reservoir after steam stimulation.

### BRIEF DESCRIPTION OF DRAWINGS

To describe the technical solutions in the examples of the present disclosure or in the prior art more clearly, the accompanying drawings required for the examples are briefly described below. Apparently, the accompanying drawings in the following description show merely some examples of the present disclosure, and a person of ordinary skill in the art may still derive other accompanying drawings from these accompanying drawings without creative efforts.

FIG. 1 is a flowchart of a method for determining a technical limit well spacing for chemical flooding for a heavy-oil reservoir according to the present disclosure.

FIG. 2 shows a driving pressure gradient curve corresponding to a 120 m well spacing according to the present disclosure.

FIG. 3 shows a starting pressure gradient curve corresponding to a 120 m well spacing according to the present disclosure.

FIG. 4 shows a relationship between a driving pressure gradient curve and a starting pressure gradient curve corresponding to a 120 m well spacing between injection and production wells according to the present disclosure.

FIG. 5 shows a relationship between a driving pressure gradient curve and a starting pressure gradient curve corresponding to a 110 m well spacing between injection and production wells according to the present disclosure.

FIG. 6 shows a relationship between a driving pressure gradient curve and a starting pressure gradient curve corresponding to a 96 m well spacing between injection and production wells according to the present disclosure.

### DETAILED DESCRIPTION

The technical solutions in the examples of the present disclosure are described below with reference to the accompanying drawings in the examples of the present disclosure. The described examples are merely a part rather than all of the examples of the present disclosure. All other examples obtained by a person of ordinary skill in the art based on the examples of the present disclosure without creative efforts shall fall within the protection scope of the present disclosure.

In order to enhance the heavy-oil reservoir recovery, an objective of the present disclosure is to provide a method and system for determining a limit well spacing for chemical flooding for a heavy-oil reservoir after steam stimulation.

In order to make the above objectives, features and advantages of the present disclosure more understandable, the present disclosure will be described in further detail below with reference to the accompanying drawings and detailed examples.

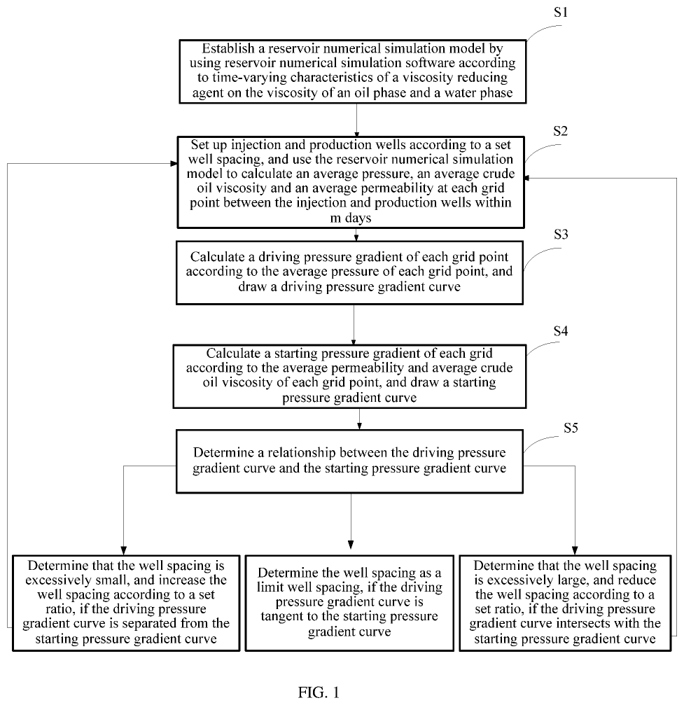

As shown in FIG. 1, the present disclosure provides a method for determining a technical limit well spacing for chemical flooding for a heavy-oil reservoir, including:

S1: Establish a reservoir numerical simulation model by using reservoir numerical simulation software according to time-varying characteristics of a viscosity reducing agent on the viscosity of an oil phase and a water phase.

S2: Set up injection and production wells according to a set well spacing, and use the reservoir numerical simulation model to calculate an average pressure, an average crude oil viscosity and an average permeability at each grid point between the injection and production wells within m days.

S3: Calculate a driving pressure gradient of each grid point according to the average pressure of each grid point, and draw a driving pressure gradient curve.

S4: Calculate a starting pressure gradient of each grid according to the average permeability and average crude oil viscosity of each grid point, and draw a starting pressure gradient curve.

S5: Determine a relationship between the driving pressure gradient curve and the starting pressure gradient curve; determine that the well spacing is excessively large if the driving pressure gradient curve intersects with the starting pressure gradient curve, then reduce the well spacing according to a set ratio, and repeat steps S2 to S5; determine that the well spacing is excessively small if the driving pressure gradient curve is separated from the starting pressure gradient curve, then increase the well spacing according to a set ratio, and repeat steps S2 to S5; and determine the well spacing as a limit well spacing when the driving pressure gradient curve is tangent to the starting pressure gradient curve.

S6: drill multiple wells according to the well spacing calculated in S5 or locate multiple wells according to the well spacing calculated in S5.

As an optional implementation, the present disclosure calculates the driving pressure gradient of each grid point specifically by:

$$D {r}_{i} = \{ \begin{matrix}\frac{p ( i ) - p ( i + 1 )}{\frac{1}{2} ( x ( i ) + x ( i + 1 ) )} & ( i = 1 , 2 , … , n - 1 ) \\ D {r}_{i - 1} & ( i = n )\end{matrix} .$$

In the formula, Drᵢ is a driving pressure gradient of an i-th grid point; n is a number of grid points; p(i) is an average pressure of the i-th grid point; x(i) is a length of the i-th grid point.

As an optional implementation, the present disclosure calculates the starting pressure gradient of each grid specifically by:

Gₒ=10^{A+BIg(K/μ}^{ₒ}⁾.

In the formula, Gₒ is a starting pressure gradient; A and B are set coefficients; K is an average permeability; μ₀ is an average crude oil viscosity.

In this example, A is 0.615, and B is −1.1915.

As an optional implementation, in the present disclosure, m is 30, and n is 80.

The present disclosure further provides a system for determining a technical limit well spacing for chemical flooding for a heavy-oil reservoir, including a model establishment module, a calculation module, a driving pressure determination module, a starting pressure determination module and a limit well spacing determination module.

The model establishment module is used for establishing a reservoir numerical simulation model by using reservoir numerical simulation software according to time-varying characteristics of a viscosity reducing agent on the viscosity of an oil phase and a water phase.

The calculation module is used for setting up injection and production wells according to a set well spacing, and using the reservoir numerical simulation model to calculate an average pressure, an average crude oil viscosity and an average permeability at each grid point between the injection and production wells within m days.

The driving pressure determination module is used for calculating a driving pressure gradient of each grid point according to the average pressure of each grid point, and drawing a driving pressure gradient curve.

The starting pressure determination module is used for calculating a starting pressure gradient of each grid according to the average permeability and average crude oil viscosity of each grid point, and drawing a starting pressure gradient curve.

The limit well spacing determination module is used for determining a relationship between the driving pressure gradient curve and the starting pressure gradient curve; determining that the well spacing is excessively large if the driving pressure gradient curve intersects with the starting pressure gradient curve, then reducing the well spacing according to a set ratio, and returning to the calculation module; determining that the well spacing is excessively small if the driving pressure gradient curve is separated from the starting pressure gradient curve, then increasing the well spacing according to a set ratio, and returning to the calculation module; and determining the well spacing as a limit well spacing when the driving pressure gradient curve is tangent to the starting pressure gradient curve.

A drilling module can be included in some implementations that controls a location or drilling of multiple wells according to the well spacing determined by the limit well spacing determination module.

As an optional implementation, the present disclosure calculates the driving pressure gradient of each grid point specifically by:

$$D {r}_{i} = \{ \begin{matrix}\frac{p ( i ) - p ( i + 1 )}{\frac{1}{2} ( x ( i ) + x ( i + 1 ) )} & ( i = 1 , 2 , … , n - 1 ) \\ D {r}_{i - 1} & ( i = n )\end{matrix} .$$

In the formula, Drᵢ is a driving pressure gradient of an i-th grid point; n is a number of grid points; p(i) is an average pressure of the i-th grid point; x(i) is a length of the i-th grid point.

As an optional implementation, the present disclosure calculates the starting pressure gradient of each grid specifically by:

Gₒ=10^{A+BIg(K/μ}^{ₒ}⁾.

In the formula, Gₒ is a starting pressure gradient; A and B are set coefficients; K is an average permeability; μ₀ is an average crude oil viscosity.

As an optional implementation, in the present disclosure, m is 30, and n is 80.

The limit well spacing of a reservoir is calculated below. The basic parameters of the reservoir include: temperature 70° C., average porosity 0.32, average permeability 2,493×10⁻³ μm², average underground crude oil viscosity 469 mPa·s, pressure difference between injection and production wells 20 MPa, mass concentration of viscosity reducer 2000 mg/L, viscosity reduction rate of viscosity reducer 90%, and mass concentration of polymer 2,000 mg/L. Specifically:

The data in Tables 1, 2 and 3 were input to the reservoir numerical simulation model.

TABLE 1
Formation crude oil viscosity changing with concentration of viscosity reducer

| | Concentration of viscosity reducer (mg/L) | | | | | | | | | | |
|---|---|---|---|---|---|---|---|---|---|---|---|
| | 0 | 300 | 600 | 900 | 1200 | 1500 | 1800 | 2100 | 2400 | 2700 | 3000 |
| Viscosity of formation crude oil mPa · s | 470 | 373 | 297 | 236 | 187 | 14 | 118 | 94 | 74 | 59 | 47 |

TABLE 2
Formation water viscosity changing with polymer concentration

| | Polymer concentration (mg/L) | | | | | | | | | | |
|---|---|---|---|---|---|---|---|---|---|---|---|
| | 0 | 300 | 600 | 900 | 1200 | 1500 | 1800 | 2100 | 2400 | 2700 | 3000 |
| Formation water viscosity mPa · s | 470 | 373 | 297 | 236 | 187 | 149 | 118 | 94 | 74 | 59 | 47 |

TABLE 3
Effective rate of viscosity reducer and polymer changing with temperature

| | Temperature/° C. | | | | | | | | |
|---|---|---|---|---|---|---|---|---|---|
| | 60 | 75 | 95 | 115 | 135 | 155 | 165 | 185 | 210 |
| Effective rate of viscosity reducer | 100 | 98.81 | 97.53 | 95.97 | 95.33 | 95.07 | 94.99 | 97.82 | 94.82 |
| Effective rate of polymer | 100 | 97.93 | 94.38 | 92.36 | 91.17 | 90.63 | 90.35 | 90.01 | 90.01 |

A spacing between injection and production wells was set to 120 m, and the reservoir numerical simulation model was used to calculate a pressure, crude oil viscosity and permeability of each grid point between the injection and production wells within 30 days.

A driving pressure gradient of each grid between the injection and production wells was calculated by

$$D {r}_{i} = \{ \begin{matrix}\frac{p ( i ) - p ( i + 1 )}{\frac{1}{2} ( x ( i ) + x ( i + 1 ) )} & ( i = 1 , 2 , … , n - 1 ) \\ D {r}_{i - 1} & ( i = n )\end{matrix} ,$$

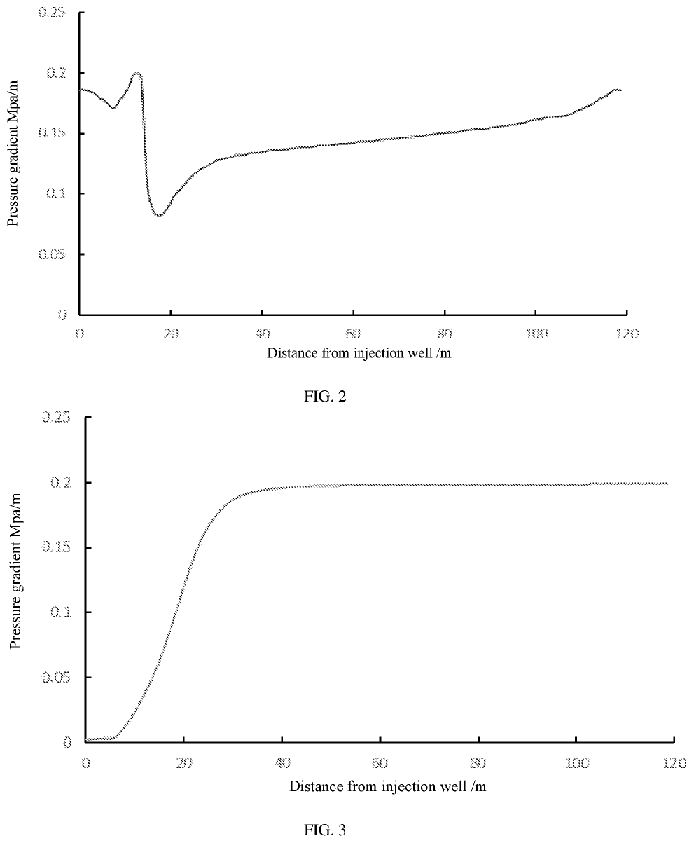

and a driving pressure gradient curve between the injection and production wells was drawn, as shown in FIG. 2.

A starting pressure gradient of each grid between the injection and production wells was calculated by Gₒ=10^{0.165-1.1915×Ig(K/μ}^{ₒ}⁾, and a starting pressure gradient curve between the injection and production wells was drawn, as shown in FIG. 3.

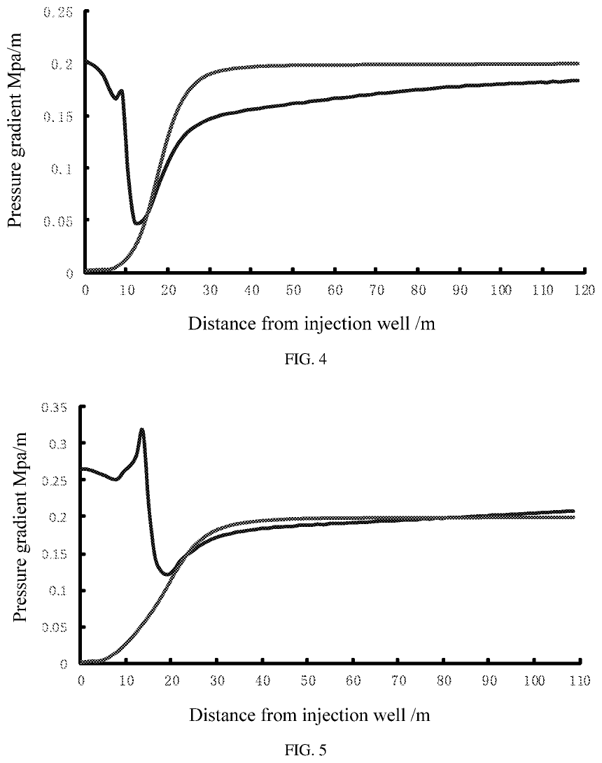

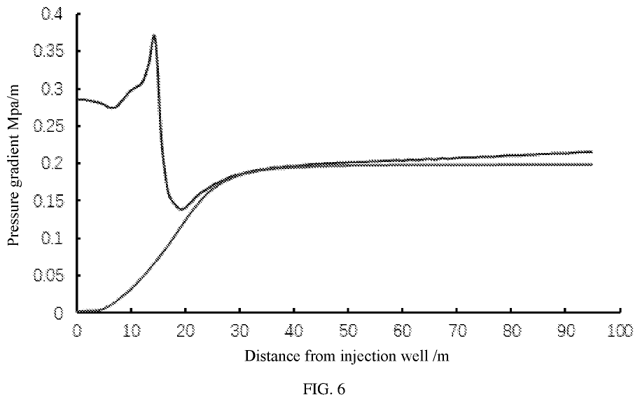

As shown in FIG. 4, when the spacing between the injection and production wells was 120 m, the driving pressure gradient curve and the starting pressure curve between the injection and production wells intersected, indicating that the injection and production wells could not be connected and the well spacing was excessively large. As shown in FIG. 5, compared with the 120 m well spacing, the pressure gradient curve corresponding to the 110 m well spacing had a stronger tendency to be tangent. As shown in FIG. 6, when the well spacing was 96 m, the starting pressure gradient curve was tangent to the driving pressure gradient curve, so the limit well spacing was 96 m.

Each example of the present specification is described in a progressive manner, each example focuses on the difference from other examples, and the same and similar parts between the examples may refer to each other. For a system disclosed in the examples, since the system corresponds to the method disclosed in the examples, the description is relatively simple, and reference can be made to the method description.

In this specification, several specific examples are used for illustration of the principles and implementations of the present disclosure. The description of the foregoing examples is used to help illustrate the method of the present disclosure and the core ideas thereof. In addition, those of ordinary skill in the art can make various modifications in terms of specific implementations and scope of application in accordance with the ideas of the present disclosure. In conclusion, the content of this specification shall not be construed as a limitation to the present disclosure.

What is claimed is:

1. A method for determining a technical limit well spacing for chemical flooding for a heavy-oil reservoir, comprising:
S1: establishing a reservoir numerical simulation model by using reservoir numerical simulation software according to time-varying characteristics of a viscosity reducing agent on a viscosity of an oil phase and a water phase of the heavy-oil reservoir;
S2: setting up injection and production wells according to a set well spacing, and using the reservoir numerical simulation model to calculate an average pressure, an average crude oil viscosity and an average permeability at a plurality of grid points between the injection and production wells over a period of m days;
S3: calculating a driving pressure gradient of each grid point according to the average pressure of each grid point, and drawing a driving pressure gradient curve;
S4: calculating a starting pressure gradient of each grid according to the average permeability and average crude oil viscosity of each grid point, and drawing a starting pressure gradient curve; and
S5: determining a relationship between the driving pressure gradient curve and the starting pressure gradient curve;
determining that the well spacing is excessively large if the driving pressure gradient curve intersects with the starting pressure gradient curve, then reducing the well spacing according to a set ratio, and repeating steps S2 to S5;
determining that the well spacing is excessively small if the driving pressure gradient curve is separated from the starting pressure gradient curve, then increasing the well spacing according to a set ratio, and repeating steps S2 to S5; and
determining the well spacing as a limit well spacing when the driving pressure gradient curve is tangent to the starting pressure gradient curve.

2. The method for determining a technical limit well spacing for chemical flooding for a heavy-oil reservoir according to claim 1, wherein the driving pressure gradient of each grid point is specifically calculated by:
$$D {r}_{i} = \{ \begin{matrix}\frac{p ( i ) - p ( i + 1 )}{\frac{1}{2} ( x ( i ) + x ( i + 1 ) )} & ( i = 1 , 2 , … , n - 1 ) \\ D {r}_{i - 1} & ( i = n )\end{matrix} ;$$
wherein, Drᵢ is a driving pressure gradient of an i-th grid point; n is a number of grid points; p(i) is an average pressure of the i-th grid point; x(i) is a length of the i-th grid point.

3. The method for determining a technical limit well spacing for chemical flooding for a heavy-oil reservoir according to claim 1, wherein the starting pressure gradient of each grid is specifically calculated by:
Gₒ=10^{A+BIg(K/μ}^{ₒ}⁾;
wherein, Gₒ is a starting pressure gradient; A and B are set coefficients; K is an average permeability; μ₀ is an average crude oil viscosity.

4. The method for determining a technical limit well spacing for chemical flooding for a heavy-oil reservoir according to claim 1, wherein m is 30, and n is 80.

5. A system for determining a technical limit well spacing for chemical flooding for a heavy-oil reservoir, comprising:
a model establishment module, for establishing a reservoir numerical simulation model by using reservoir numerical simulation software according to time-varying characteristics of a viscosity reducing agent on the viscosity of an oil phase and a water phase;
a calculation module, for setting up injection and production wells according to a set well spacing, and using the reservoir numerical simulation model to calculate an average pressure, an average crude oil viscosity and an average permeability at each grid point between the injection and production wells within m days;
a driving pressure determination module, for calculating a driving pressure gradient of each grid point according to the average pressure of each grid point, and drawing a driving pressure gradient curve;
a starting pressure determination module, for calculating a starting pressure gradient of each grid according to the average permeability and average crude oil viscosity of each grid point, and drawing a starting pressure gradient curve; and
a limit well spacing determination module, for determining a relationship between the driving pressure gradient curve and the starting pressure gradient curve; determining that the well spacing is excessively large if the driving pressure gradient curve intersects with the starting pressure gradient curve, then reducing the well spacing according to a set ratio, and returning to the calculation module; determining that the well spacing is excessively small if the driving pressure gradient curve is separated from the starting pressure gradient curve, then increasing the well spacing according to a set ratio, and returning to the calculation module; and determining the well spacing as a limit well spacing when the driving pressure gradient curve is tangent to the starting pressure gradient curve.

6. The system for determining a technical limit well spacing for chemical flooding for a heavy-oil reservoir according to claim 5, wherein the driving pressure gradient of each grid point is specifically calculated by:
$$D {r}_{i} = \{ \begin{matrix}\frac{p ( i ) - p ( i + 1 )}{\frac{1}{2} ( x ( i ) + x ( i + 1 ) )} & ( i = 1 , 2 , … , n - 1 ) \\ D {r}_{i - 1} & ( i = n )\end{matrix} ;$$
wherein, Drᵢ is a driving pressure gradient of an i-th grid point; n is a number of grid points; p(i) is an average pressure of the i-th grid point; x(i) is a length of the i-th grid point.

7. The method for determining a technical limit well spacing for chemical flooding for a heavy-oil reservoir according to claim 5, wherein the starting pressure gradient of each grid is specifically calculated by:
Gₒ=10^{A+BIg(K/μ}^{ₒ}⁾;
wherein, Gₒ is a starting pressure gradient; A and B are set coefficients; K is an average permeability; μ₀ is an average crude oil viscosity.

8. The method for determining a technical limit well spacing for chemical flooding for a heavy-oil reservoir according to claim 5, wherein m is 30, and n is 80.
